(19) United States
(12) Patent Application Publication
(10) Pub. No.: US 2011/0077822 A1
(43) Pub. Date: Mar. 31, 2011

(54) REMOTE CONTROL OF SLIDING TRAILER SUSPENSION LOCK PINS

(76) Inventors: Kenneth G. Lang, Davison, MI (US); William Larry Burgin, Clarkston, MI (US)

(21) Appl. No.: 12/568,691

(22) Filed: Sep. 29, 2009

(51) Int. Cl. G06F 19/00; B60G 5/00

(52) U.S. Cl. 701/37

(57) ABSTRACT

A trailer sliding suspension is remotely controlled to move between locked and unlocked positions. To unlock the sliding suspension, the driver initiates generation of a first signal which is communicated to an electronic control unit of a trailer anti-lock brake system. The electronic control unit then generates an unlocking signal in response to the first signal to unlock the sliding suspension such that a position of the sliding position can be adjusted relative to a trailer supported by the sliding suspension. Once the sliding suspension is in the desired position, the driver generates a second signal which is communicated to the electronic control unit. The electronic control unit then generates a locking signal in response to the second signal to lock the sliding suspension to a trailer body rail.

### TECHNICAL FIELD

The subject invention relates to a trailer sliding suspension with lock pins that can be controlled from a location remote from the sliding suspension.

### BACKGROUND OF THE INVENTION

Trailers are used to transport large amounts of goods to various locations. The trailers are coupled to a vehicle, such as a semi-tractor for example, which then transports the trailer to a desired location. A significant portion of existing trailers utilize a sliding tandem suspension that includes a series of lock pins. The pins lock into trailer body side rails to fix the suspension to the trailer. The pins can be unlocked to adjust a position of the sliding suspension along the trailer. The position of the suspension is adjustable to change axle weight distribution, improve maneuverability, and/or to accommodate for unloading or loading of goods.

In order to reposition the sliding suspension, a driver must first exit a cab of the tractor and walk to a rear of the trailer to release/unlock the pins from the trailer side rails. The driver then returns to the cab and drives the tractor to reposition the sliding suspension by moving the trailer relative to the sliding suspension. Once the suspension is in the desired position, the driver must again exit the cab to re-engage the pins within corresponding holes in the trailer side rails. The driver then returns to the cab to ensure that the pins lock into the holes by slightly moving the suspension. Finally, the driver then exits the cab for a third time and walks to the rear of the trailer to visually confirm that all pins have engaged within the holes such that the suspension is securely locked in place. Such a procedure is time consuming and difficult especially when conducted during adverse weather conditions.

### SUMMARY OF THE INVENTION

A trailer sliding suspension is remotely controlled in response to locking and unlocking requests.

In one example, to unlock the sliding suspension, a user generated first signal is communicated to an electronic control unit of a trailer anti-lock brake system. The electronic control unit then generates an unlocking signal in response to the first signal to unlock the sliding suspension such that a position of the sliding position can be adjusted relative to a trailer supported by the sliding suspension. Once the sliding suspension is in the desired position, a second signal is generated which is communicated to the electronic control unit. The electronic control unit then generates a locking signal in response to the second signal to lock the sliding suspension to a trailer body rail.

In one example, a trailer sliding suspension includes at least one lock pin that is movable between a locked position where the lock pin engages in an opening in the trailer body rail and an unlocked position where the lock pin is disengaged from the trailer body rail. A peripheral device is configured to control movement of the lock pins in response to the unlocking and locking signals.

These and other features of the present invention can be best understood from the following specification and drawings, the following of which is a brief description.

### BRIEF DESCRIPTION OF THE DRAWINGS

FIG. 1 is a side view of a tractor-trailer vehicle incorporating a trailer sliding suspension.

FIG. 2 is a schematic diagram of a control system for the trailer sliding suspension which incorporates the subject invention.

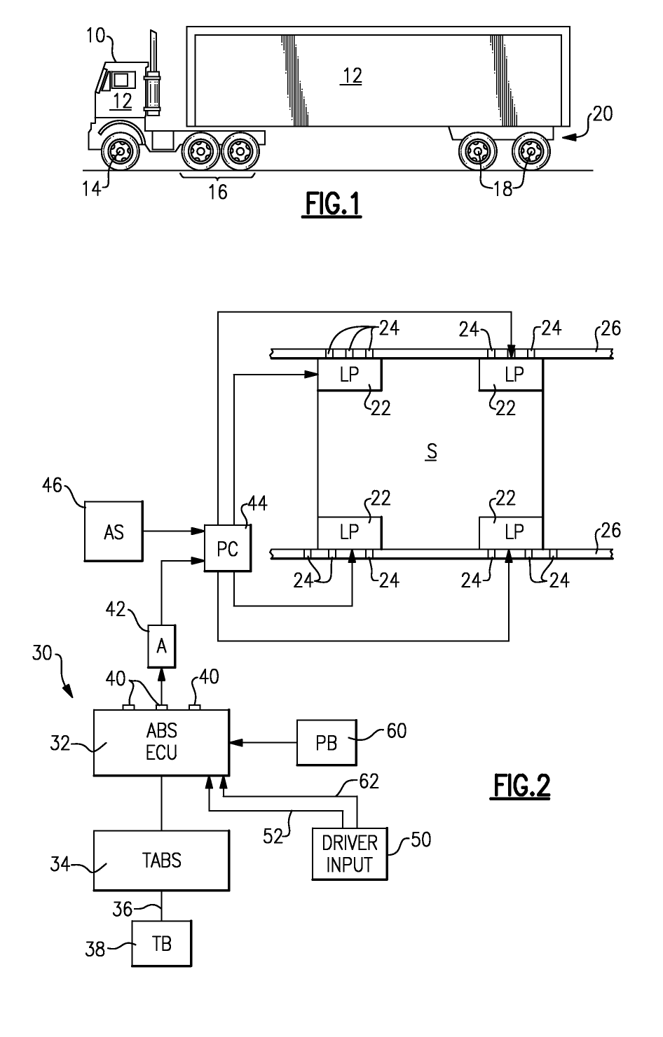

### DETAILED DESCRIPTION OF THE PREFERRED EMBODIMENT

A tractor 10 is coupled to a trailer 12, which is used to transport goods to a desired location. The tractor 10 includes a front steer axle 14 and a tandem rear drive axle 16 over which a front portion of the trailer 12 extends. The front steer axle can comprise a non-drive or drive axle, and optionally, a single rear drive axle or a tridem rear drive axle can be used. A rear portion of the trailer 12 is supported on a set of trailer axles 18. A trailer sliding suspension 20 is used to support this rear portion of the trailer 12 at the trailer axles 18. The trailer sliding suspension 20 can comprise a sliding single, tandem, or tridem trailer suspension depending on the rear axle configuration. The figures show a sliding tandem trailer suspension as an example with the understanding that the sliding single and tridem trailer suspension would operate in a similar manner.

The trailer sliding suspension 20 is movable between a locked position and an unlocked position. When in an unlocked position, a driver can drive the tractor 10 to adjust a position of the sliding suspension 20 along a length of the trailer 12. Once the sliding suspension 20 is at the desired position relative to the trailer 12, the sliding suspension 20 is then returned to the locked position.

A highly schematic representation of one example of a trailer sliding suspension 20 is shown in FIG. 2. The sliding suspension 20 includes at least one locking pin 22 that is received within an opening 24 formed in a trailer body rail 26. In the example shown, a plurality of lock pins 22 are utilized with a pair of trailer body rails 26, which are located on opposing sides of the trailer 12. The body rails 26 include a plurality of openings 24. The lock pins 22 are moveable between a locked position wherein each pin 22 is received within one opening 24 and an unlocked position where the pins 22 are moved out of the openings 24. When in the unlocked position the trailer 12 is moved relative to the sliding suspension 20 such that the lock pins 22 are aligned with a different set of openings 24. When the sliding suspension 20 is in the desired position relative to the trailer 12, the pins 22 are then re-engaged within the respective aligned openings 24 in the trailer body rails 26 to lock the suspension 20 securely in place.

A control system 30 is used to control locking and unlocking movement of the lock pins 22 of the trailer sliding suspension 20. The control system 30 is configured to allow this movement to be controlled from a location that is remote from the trailer sliding suspension 20. This is beneficial compared to traditional control systems which require the driver to walk back to the sliding suspension to manually initiate locking and unlocking movement of the pins 22. It should be understood that the trailer sliding suspension 20 schematically shown in FIG. 2 is just one example of a sliding suspension configuration and the control system 30 can be used to control any type of trailer sliding suspension.

The control system 30 comprises an electronic control unit (ECU) 32 from a trailer anti-lock brake system (TABS) 34. The ECU 32 generates output signals 36 to control trailer brakes 38 in response to braking requests. The ECU 32 includes one or more additional 12 volt outputs 40 that are used to run peripheral devices.

In one example, one peripheral device comprises an actuator 42 that is electrically connected to an output 40 and is used to control operation of a control 44 that controls movement of the lock pins 22. In one example, the control 44 comprises a pneumatic controller in fluid communication with an air supply 46 that can either be a dedicated air supply or part of the TABS 34. In one example, the actuator 42 comprises an electric solenoid that is used to operate the pneumatic controller; however, other types of actuators could also be used.

To adjust a position of the sliding suspension 20, the driver initiates an unlocking request which is communicated to the ECU 32. In one example, the driver actuates an input device 50 which generates a first signal 52 which is communicated to the ECU 32.

In one example, the first signal is generated from the input device 50 in response to the driver performing a predefined vehicle operation a specified number of times within a predetermined period of time. In one example, the input device 50 is located within a cab of the tractor 10 and can be one of many different types of inputs such as a brake pedal for example. The brake pedal is quickly and repeatedly depressed after a parking brake 60 has been set. In one example, the brake pedal is depressed at least three times within a short period of time comprising ten seconds or less. Once the pedal has been depressed the correct number of times within the specified time period, the first signal 52 is communicated to the ECU 32.

In response to receipt of the first signal 52, the ECU 32 generates an unlocking signal which is communicated to the actuator 42, which in turn controls the pneumatic control 44 of the sliding suspension 20 to move the lock pins 22 to the unlocked position. This occurs while the driver remains in the cab. Once the pins 22 have been unlocked, the driver can then move the trailer 12 relative to the sliding suspension 20 to locate the sliding suspension 20 at a desired location along the trailer 12.

Once the sliding suspension 20 is in the correct location, the driver initiates a locking request which is communicated to the ECU 32. In one example, the driver actuates the input device 50 which generates a second signal 62 that is communicated to the ECU 32. The second signal 62 can be generated through a manner similar to that for the unlocking signal, i.e. depressing the brake pedal a minimum number of times within a specified time period, or another type of driver input can be used to generate the second signal 62.

In response to receipt of the second signal 62, the ECU 32 generates a locking signal which is communicated to the actuator 42. The actuator 42 then controls the pneumatic control 44 to re-engage the lock pins 22 within the openings 24 to securely lock the sliding suspension 20 to the body rails 26. Only after the sliding suspension 20 has been re-locked, does the driver have to then exit the cab to visually verify that the pins are properly engaged within the openings.

It should be understood that the ECU 32 of the TABS 34 is pre-programmed with software to recognize the first and second signals initiated by driver actions such that the ECU 32 can then provide 12 volts to the appropriate output 40 to control the actuator 42. In this manner, the driver can control movement of the lock pins from the cab in a simple and effective way without requiring expensive add-on devices.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method for controlling a sliding trailer suspension system comprising the steps of:
(a) generating a first signal in response to an initial driver request;
(b) communicating the first signal to an electronic control unit of a trailer anti-lock brake system;
(c) generating an unlocking signal in response to the first signal to unlock a trailer sliding suspension from a trailer body rail;
(d) generating a second signal in response to a subsequent driver request;
(e) communicating the second signal to the electronic control unit; and
(f) generating a locking signal in response to the second signal to lock the trailer sliding suspension to the trailer body rail.

2. The method according to claim 1 including adjusting a position of a trailer relative to the trailer sliding suspension prior to step (d) and subsequent to step (c).

3. The method according to claim 1 wherein at least one of step (a) and step (d) includes performing a user initiated operation a specified number of times within a predetermined period of time.

4. The method according to claim 3 wherein the specified number of times comprises at least 3 times.

5. The method according to claim 4 wherein the predetermined period of time is less than 10 seconds.

6. The method according to claim 3 wherein both step (a) and step (d) include performing a user initiated operation a specified number of times within a predetermined period of time.

7. The method according to claim 3 wherein the user initiated operation comprises performing service brake applications while a parking brake is set.

8. The method according to claim 1 wherein the electronic control unit generates output signals to control trailer brakes and includes at least one additional output to control a peripheral device, and wherein step (c) includes communicating the unlocking signal to the peripheral device to move lock pins of the trailer sliding position from a locked position to an unlocked position.

9. The method according to claim 8 wherein the peripheral device comprises a solenoid and including actuating the solenoid to control a pneumatic controller that controls movement of the lock pins.

10. The method according to claim 1 wherein step (a) includes generating the first signal from a location that is remote from a trailer supported by the trailer sliding suspension.

11. A control system for a trailer sliding suspension comprising:
a trailer anti-lock brake system electronic control unit that receives a first signal in response to a trailer suspension unlock request, said trailer anti-lock brake system electronic control unit generating an unlocking signal in response to the first signal to unlock a trailer sliding suspension from a trailer body rail to allow suspension adjustment, and wherein said trailer anti-lock brake system electronic control unit generates a locking signal in response to a subsequent trailer suspension lock request to lock the trailer sliding suspension to the trailer body rail.

12. The control system according to claim 11 including an input device selectively actuated by a driver located remotely from the trailer sliding suspension to generate said first signal.

13. The control system according to claim 11 wherein said trailer sliding suspension includes at least one lock pin that is movable between a locked position where said lock pin engages in an opening in the trailer body rail and an unlocked position where said lock pin is disengaged from the trailer body rail, and including a peripheral device that is configured to control movement of said lock pin in response to said unlocking and locking signals.

14. The control system according to claim 13 wherein said peripheral device comprises a solenoid that operates a pneumatic controller of said trailer sliding suspension.

15. The control system according to claim 11 wherein said trailer anti-lock brake system electronic control unit generates output signals to control operation of trailer brakes and wherein said trailer anti-lock brake system electronic control unit includes at least one additional output that controls said peripheral device.
